(19) United States
(12) Patent Application Publication
(10) Pub. No.: US 2003/0174840 A1
(43) Pub. Date: Sep. 18, 2003

(54) Encryption method for preventing unauthorized dissemination of protected data

(76) Inventor: William B. Bogan, Bristow, VA (US)

Correspondence Address: Intellectual Property Support Services, LLC, 21576 Kouros Ct., Ashburn, VA, 20147, US

(21) Appl. No.: 10/094,822

(22) Filed: Mar. 12, 2002

(51) Int. Cl. H04L 9/00

(52) U.S. Cl. 380/277

(57) ABSTRACT

A method which prevents the unauthorized dissemination of protected data in a client-server environment through the use of partial, or split key encryption. An encrypted symmetric key is first split, and each split is then transformed. The transformed splits are then separated between client and server and the encrypted key is destroyed. To recombine the splits for the purpose of encrypting or decrypting then requires a connection between client and server in which either the server-side split is sent to the client or the client-side split is sent to the server. A reverse transformation is then performed on both client-side and server-side splits, the splits are recombined, and the resulting encrypted key can then be used with either traditional symmetric key cryptography, or as a private key in public key cryptography, provided the means to decrypt and use the key already exist.

### FIELD OF THE INVENTION

This invention relates in general to the field of data encryption and security, in particular to partial or split key encryption.

### BACKGROUND OF THE INVENTION

In today's computer-based and data-driven society where information is increasingly easy to access, the need for data security and encryption continues to soar. Attention today is highly focused upon public key, or asymmetric methods of encryption which frequently require large and expensive infrastructures. Accordingly, these infrastructures are known simply as Public Key Infrastructures, or PKI.

PKI and other public key encryption methods are based upon a 2-key method, one public and one private, whereby an individual's public key is used to encrypt data for their use once it is decrypted with their private key. As the names imply, the public key is available to all, and the private key is closely guarded by the individual. While public key cryptography has solved the age-old problem of key distribution evident in symmetric (or 1-key) key encryption systems, it has not addressed another growing, and more insidious, problem.

At the very heart of PKI is the element of trust. Trust, unfortunately, has proven to be highly subjective in the Internet Era. With PKI, digital certificates are issued to users in an effort to provide trusted authentication and access to systems and information. Missing from PKI, however, is a failsafe method for protecting sensitive data in the event that trust is violated. An example of the trust being violated is that of insider threat of theft of proprietary data.

### SUMMARY OF THE INVENTION

In split key cryptography, an encryption key is split, or reduced, into two (or more) partitions. These partitions are then mathematically transformed such that the key can be reconstructed only from the combination of the splits after they have undergone reverse transformation. Once the transformed splits are created, the original key is then destroyed or escrowed, as required, to prevent its misuse. Assuming that data has been encrypted with the complete key, no single split would thus be sufficient for decryption. Once a key is split, it is then obviously desirable to store the individual splits in physically separate locations. One such logical arrangement is to store one half of the split on a server, and the other on a client. Some examples of client/server relationships would be network system/cellular phone, workstation/smartcard, laptop/PC card, or CD proprietary software/host computer at development. However, these only a few examples of the wide variety of clients and servers. The present invention is not limited to those examples previously stated above.

With such an arrangement, then, the client and server would need to initiate a session in order for either the server to send its split to the client, or vice-versa for the client to send its split to the server. In either case, the split from the transmitting source would act as a session variable, and would be lost if the session were terminated.

Furthermore, a server could hold a number of splits for a number of separate clients. Conversely, a single client may hold multiple splits for various servers.

The preferred invention provides for a method to prevent the unauthorized dissemination of protected data in a client-server environment through the use of partial, or split key encryption. An encrypted symmetric key is first split, and each split is then transformed. The transformed splits are then separated between client and server and the encrypted key is destroyed. To recombine the splits for the purpose of encrypting or decrypting then requires a connection between client and server in which either the server-side split is sent to the client or the client-side split is sent to the server. A reverse transformation is then performed on both client-side and server-side splits, the splits are recombined, and the resulting encrypted key can then be used with either traditional symmetric key cryptography, or as a private key in public key cryptography, provided the means to decrypt and use the key already exist. The split transformation can be made unique to a specific device, serial number or CD Key, specific user authentication, or any combination therein. Since the transformed splits are encrypted prior to transformation, a secure communications link is not required.

### BRIEF DESCRIPTION OF THE DRAWINGS

The invention is pointed out with particularity in the appended claims. However, a more complete understanding of the present invention may be derived by referring to the detailed description and claims when considered in connection with the figures, wherein like reference numbers refer to similar items throughout the figures, and;

FIG. 1 is a diagram depicting a client/server system;

FIG. 2 is a diagram illustrating a process for generating splits; and

FIG. 3 is a diagram illustrating a process for recombining splits.

The exemplification set out herein illustrates a preferred embodiment of the invention in one form thereof, and such exemplification is not intended to be construed as limiting in any manner.

### DESCRIPTION OF THE PREFERRED EMBODIMENT

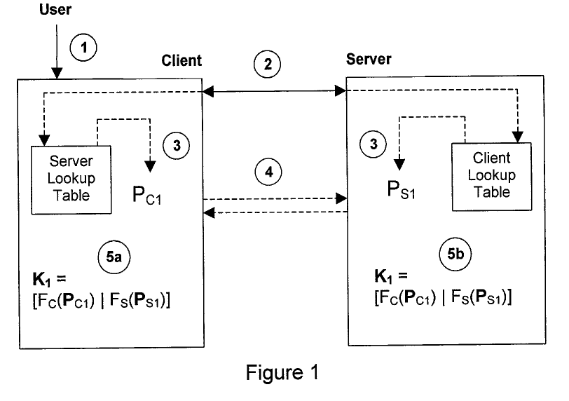

FIG. 1 depicts a representative client-server environment in which the invention would reside, and assumes that the transformed splits have already been created. In step 1, the user authenticates himself/herself to the client (and by inference the network) and initiates a session with the server in step 2. As a part of the session initiation, both client and server extract the appropriate transformed split for the other half (step 3), by means of a simple lookup table or database. The table and/or database lookup can be facilitated with information discovered during the session initiation. In steps 4 and 5, the transformed splits undergo reverse transformation with a predetermined input value and are then recombined. The predetermined input value for the client can be either the same or different from the predetermined input value for the server.

Depending upon the needs of the application, the recombination can occur on the client (step 5a) or on the server (step 5b). If desired, the transmission of one transformed split to the other party can occur via a secure link like a Secure Socket Layer (SSL), however, assuming the original key is encrypted itself, this is not necessary. It is important, however, that the means to decrypt the original key also be made readily available.

If an attacker were to intercept the transformed split in transmission, he/she would still be unable to create a recombined key even if they later possessed the hardware hosting the other transformed split. Without an exact match of the input function for the reverse transformation, it is impossible to recreate the original key. Once the client (server) has received the transformed split from the server (client), and recombined the two splits into a single key, the recombined key resides in temporary memory as a session variable. The key can then be used for file/disk encryption/decryption as implemented by a host application. When the session is terminated, the recombined key is thus lost, and data encrypted/decrypted with the key will then require a new session in order to recombine the key.

Furthermore, a server could hold a number of splits for a number of separate clients. Conversely, a single client may hold multiple splits for various servers.

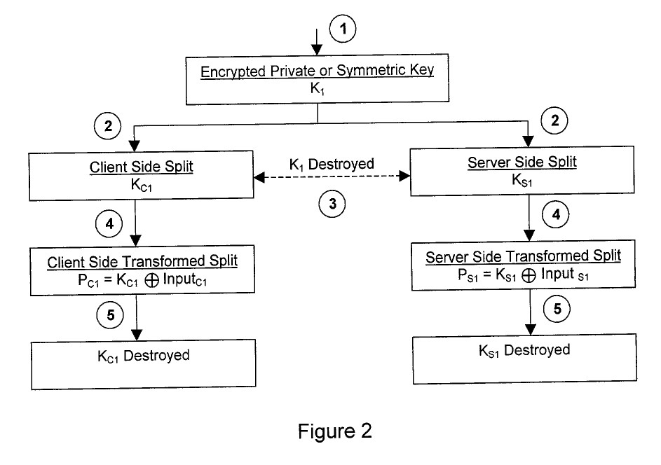

FIG. 2 depicts the process of creating transformed splits from a single encryption key. Although the figure and description illustrate two splits, this process could be extended to a third split for use within a token or smart card for added security. In step 1, a single (encrypted) key K₁ exists, for use either in a symmetric key encryption system, or as an individual private key within a PKI. In steps 2 and 3, K₁ is split in two halves K_{C1} and K_{S1}, and the original key K₁ is destroyed or escrowed, as desired. The original key can be destroyed by deleting it. In step 4, the two splits K_{C1} and K_{S1} are then transformed into P_{C1} and P_{S1} respectively by means of an XOR operation with a predetermined input value.

The predetermined input value used depends upon the nature of the application, and can be used to make the resulting transformed splits unique to a particular client/server pair and user. Some examples of the input value would be CD specific key for software distribution or piracy prevention; User Authentication (Password or Password XOR Biometric) for corporate networks or PKI Key Management; or User Authentication XOR Machine ID for highly secure operating environments for military or mobile devices. These examples of input value are not intended to limit the present invention and its scope. There are a wide variety of possible input values. Another application would be an automated need to know basis.

Step 5 then destroys or escrows, as desired, the untransformed key splits K_{C1} and K_{S1} to ensure that a reverse transformation must first be performed before the split keys can be recombined.

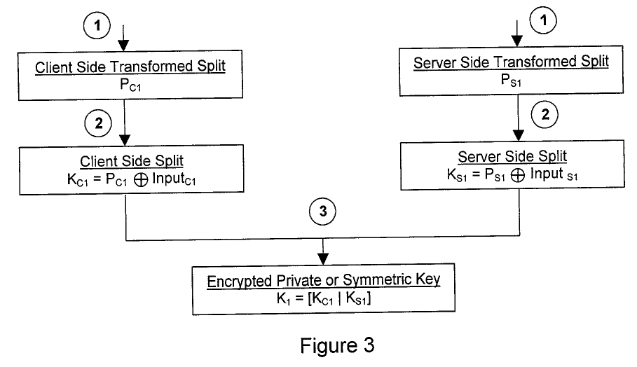

FIG. 3 depicts the process of reclaiming the original key from the two transformed splits. In steps 1 and 2, the transformed splits P_{C1} and P_{S1} undergo a reverse transformation into K_{C1} and K_{S1}, respectively by means of an XOR operation with the same predetermined input value for transformation. The original key K1 can then be formed by sequentially recombining K_{C1} and K_{S1}, however, the sequencing does not need to be back-to-back, but rather can result from a predetermined interleaving process for added security.

Each split key that is obtained from the original encryption key and has undergone reverse transformation can be stored in long term memory for later use, if desired. It should be noted, however, that this represents an increased security risk.

It is important to note that since the object of the invention is to prevent the unauthorized dissemination of protected data from individuals with trusted access, the recombined key cannot reside in long term memory outside of the active session. Furthermore, it can also be assumed that the encryption/decryption occurs at the I/O interface such that the default state of data at rest is encrypted. Because of the simple nature of the transformation, this process can easily be accomplished in hardware whereby buffers can be established for the temporary storage of transformed splits needed to recreate the original key.

I hereby claim:

1. A method for protecting data by encrypting data through the use of partial key encryption, the method comprising the steps of:
splitting an encryption key into partial keys;
transforming each partial key;
storing each transformed partial key in either a client or server;
initiating a session between the client and server;
reverse transforming each transformed partial key; and
recombining each partial key to obtain the encryption key.

2. A method as claimed in claim 1, further comprising the step of decrypting the recombined encryption key.

3. A method as claimed in claim 1, further comprising the step of obtaining a corresponding server side transformed partial key through a lookup table or database.

4. A method as claimed in claim 1, further comprising the step of obtaining a corresponding client side transformed partial key through a lookup table or database.

5. A method as claimed in claim 1, further comprising the step of storing a plurality of partial keys in the server.

6. A method as claimed in claim 5, wherein the client comprises a plurality of clients.

7. A method as claimed in claim 1, further comprising the step of storing a plurality of partial keys in the client.

8. A method as claimed in claim 7, wherein the server comprises a plurality of servers.

9. A method as claimed in claims 3, further comprising the step of sending the corresponding server side transformed partial key to the client.

10. A method as claimed in claim 4, further comprising the step of sending the corresponding client side transformed partial key to the server.

11. A method as claimed in claim 1, wherein the step of recombining can occur either in the client or server.

12. A method as claimed in claim 10, wherein the step of recombining further comprises the step of sequencing back-to-back.

13. A method as claimed in 10, wherein the step of recombining further comprises the step of interleaving.

14. A method as claimed in claim 1, wherein the step of transforming further comprises the step of inputting a predetermined input value.

15. A method as claimed in claim 14, further comprises the step of exclusive ORing the predetermined input value with each partial key.

16. A method as claimed in claim 14, wherein the step of reverse transforming further comprises the step of exclusive ORing the predetermined input value with each transformed partial key.

17. A method as claimed in claim 15, wherein the step of reverse transforming further comprises the step of exclusive ORing the predetermined input value with each transformed partial key.

18. A method for protecting data by generating partial keys from an encryption key, the method comprising the steps of:
splitting the encryption key into partial keys;
destroying the encryption key;
transforming each partial key to obtain transformed partial keys; and
destroying each partial key.

19. A method as claimed in claim 18, further comprising the step of inputting a predetermined input value.

20. A method as claimed in claim 19, wherein the transforming step further comprises the step of exclusive ORing the predetermined input value with each partial key.

21. A method as claimed in claim 18, further comprising the step of inputting a separate predetermined input value for each partial key.

22. A method as claimed in claim 21, wherein the transforming step further comprises the step of exclusive ORing each predetermined input value with a respective partial key.

23. A method as claimed in claim 21, wherein each separate predetermined input value has a different value.

24. A method as claimed in claim 22, wherein each separate predetermined input value has a different value.

25. A method as claimed in claim 18, further comprising the step of storing each transformed partial key in either a client or server.

26. A method as claimed in claim 18, wherein the step of splitting the encryption key into partial keys generates more than 2 partial keys.

27. A method for protecting data by generating an encrypted key from transformed partial keys, the method comprising the steps of:
initiating a session between a client and server;
reverse transforming each transformed partial key to obtain partial keys; and
recombining each partial key.

28. A method as claimed in claim 27, further comprising the step of inputting a predetermined input value.

29. A method as claimed in claim 29, wherein the reverse transforming step further comprises the step of exclusive ORing the predetermined input value with each transformed partial key.

30. A method as claimed in claim 27, further comprising the step of inputting a separate predetermined input value for each transformed partial key.

31. A method as claimed in claim 30, wherein the reverse transforming step further comprises the step of exclusive ORing each predetermined input value with a respective partial key.

32. A method as claimed in claim 30, wherein each separate predetermined input value has a different value.

33. A method as claimed in claim 31, wherein each separate predetermined input value has a different value.

34. A method as claimed in claim 27, wherein the step of recombining can occur either in the client or server.
